(19) United States
(12) Patent Application Publication
(10) Pub. No.: US 2015/0332195 A1
(43) Pub. Date: Nov. 19, 2015

(54) FACILITATING PERFORMANCE MONITORING FOR PERIODICALLY SCHEDULED WORKFLOWS

(71) Applicant: Linkedln Corporation, Mountain View, CA (US)

(72) Inventor: Brian F. Jue, Foster City, CA (US)

(73) Assignee: Linkedln Corporation, Mountain View, CA (US)

(21) Appl. No.: 14/276,605

(22) Filed: May 13, 2014

(51) Int. Cl. G06Q 10/06

(52) U.S. Cl. CPC G06Q 10/06316

(57) ABSTRACT

The disclosed embodiments provide a system for monitoring the performance of periodically scheduled workflows and associated jobs while they are executing a computing cluster. During operation, the system monitors the total execution time for the workflow. While monitoring the total execution time for the workflow, the system also monitors execution times for individual jobs in the set of jobs that comprise the workflow. The system also periodically determines an execution-time threshold for the workflow based on prior executions of the workflow. If the monitored execution time for the workflow exceeds the determined execution-time threshold for the workflow, the system sends an alert about the workflow to a user. The system also enables the user to examine the monitored execution time for the workflow and the monitored execution times for the associated jobs. This helps the user to determine a solution to a performance problem for the workflow.

### RELATED ART

The disclosed embodiments generally relate to techniques for executing computational workflows on computing clusters. More specifically, the disclosed embodiments relate to a technique for monitoring the performance of periodically scheduled workflows and associated jobs while they are executing on a computing cluster.

### BACKGROUND

Perhaps the most significant development on the Internet in recent years has been the rapid proliferation of online social networks, such as Facebook™ and LinkedIn™. Billions of users are presently accessing such online social networks to connect with friends and acquaintances and to share personal and professional information. However, to operate effectively, these online social networks need to perform a large number of computational operations. For example, an online professional network typically executes computationally intensive algorithms to identify other members of the network that a given member will want to link to.

These computational operations are often performed using periodically scheduled “workflows,” wherein each workflow comprises a collection of interdependent jobs that are scheduled to execute on nodes of a computing cluster. Note that this type of computing cluster can comprise a multi-tenant system, such as Apache Hadoop™. The scheduling process can be somewhat complicated because an intricate dependency chain exists among the jobs that comprise a task, and the scheduler must ensure that all preceding jobs in a dependency graph complete before a given job can execute.

Moreover, these periodically scheduled workflows can encounter performance problems during execution. For example, a node in the computing cluster can have performance problems, and this problematic node can cause a job to be delayed, which can prevent an associated workflow from completing. Therefore, to ensure successful completion of such scheduled workflows, it is necessary to carefully monitor the performance of the workflows and associated jobs to detect performance problems, thereby enabling remedial actions to be performed. For example, a remedial action can involve moving a delayed job from a problematic node to another node in the computing cluster.

Hence, what is needed is a system that facilitates monitoring the performance of periodically scheduled workflows and associated jobs in the computing cluster.

### BRIEF DESCRIPTION OF THE FIGURES

FIG. 1 illustrates a computing environment for an online social network in accordance with the disclosed embodiments.

FIG. 2 illustrates how jobs represented as “flow graphs” are executed on a computing cluster in accordance with the disclosed embodiments.

FIG. 3 presents a flow chart illustrating how a workflow is monitored in accordance with the disclosed embodiments.

FIG. 4 presents a flow chart illustrating how an execution-time threshold is calculated in accordance with the disclosed embodiments.

FIG. 5 presents a flow chart illustrating how the system enables a user to examine statistics for the monitored workflow in accordance with the disclosed embodiments.

FIG. 6 illustrates a landing page including an “accordion view” in accordance with the disclosed embodiments.

FIG. 7 illustrates a workflow view for the monitoring tool in accordance with the disclosed embodiments.

FIG. 8 illustrates a monitoring-configuration view for the monitoring tool in accordance with the disclosed embodiments.

FIG. 9 illustrates an alerts view for the monitoring tool in accordance with the disclosed embodiments.

### DESCRIPTION

The following description is presented to enable any person skilled in the art to make and use the disclosed embodiments, and is provided in the context of a particular application and its requirements. Various modifications to the disclosed embodiments will be readily apparent to those skilled in the art, and the general principles defined herein may be applied to other embodiments and applications without departing from the spirit and scope of the disclosed embodiments. Thus, the disclosed embodiments are not limited to the embodiments shown, but are to be accorded the widest scope consistent with the principles and features disclosed herein.

The data structures and code described in this detailed description are typically stored on a computer-readable storage medium, which may be any device or medium that can store code and/or data for use by a system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored on a non-transitory computer-readable storage medium as described above. When a system reads and executes the code and/or data stored on the non-transitory computer-readable storage medium, the system performs the methods and processes embodied as data structures and code and stored within the non-transitory computer-readable storage medium.

Furthermore, the methods and processes described below can be included in hardware modules. For example, the hardware modules can include, but are not limited to, application-specific integrated circuit (ASIC) chips, field-programmable gate arrays (FPGAs), and other programmable-logic devices now known or later developed. When the hardware modules are activated, the hardware modules perform the methods and processes included within the hardware modules.

### Overview

The disclosed embodiments provide a system for monitoring the performance of periodically scheduled workflows and associated jobs while they are executing a computing cluster. During operation, the system monitors the total execution time for the workflow, wherein the workflow comprises a set of jobs that execute on nodes of a computing cluster. While monitoring the total execution time for the workflow, the system also monitors execution times for individual jobs in the set of jobs that comprise the workflow. The system also periodically determines an execution-time threshold for the workflow based on prior executions of the workflow. If the monitored execution time for the workflow exceeds the determined execution-time threshold for the workflow, the system sends an alert about the workflow to a user. The system also enables the user to examine the monitored execution time for the workflow and the monitored execution times for the associated jobs. This can potentially help the user to determine a solution to a performance problem for the workflow.

In some embodiments, the system also determines execution-time thresholds for jobs that comprise the workflow based on previous executions of the jobs. Then, if an execution time for a job exceeds the determined execution-time threshold for the job, the system sends an alert about the job to the user.

In some embodiments, the system also enables the user to examine a dependency graph for the workflow to facilitate determining a solution to a performance problem for the workflow. This dependency graph specifies dependencies between jobs in the workflow, wherein a dependency between a first job and a second job indicates that the first job must complete before the second job can begin executing.

In some embodiments, while determining the execution-time threshold, the system first determines a mean value and a standard deviation for the execution time for the workflow based on prior successful executions of the workflow. Next, the system adds the determined standard deviation and a buffer time to the determined mean value to produce the execution-time threshold.

In some embodiments, the system additionally monitors values for one or more internal counters for events associated with the flow, and then enables the user to examine the monitored values for the one or more internal counters.

Before describing details of the operation of the monitoring system, we first describe a computing environment that contains the monitoring system.

### Computing Environment

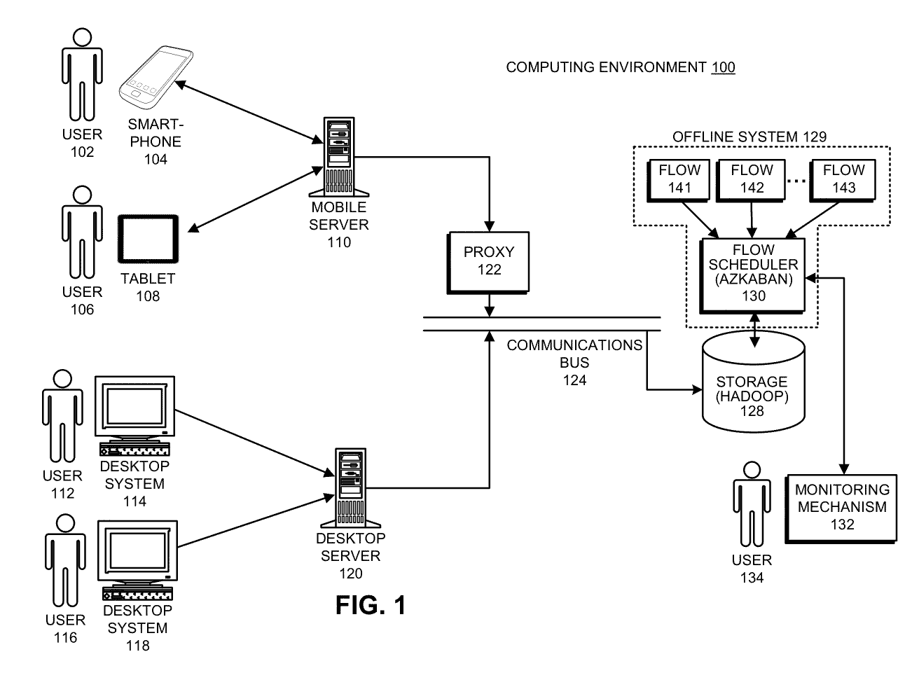

FIG. 1 illustrates an exemplary computing environment 100 that supports an online social network in accordance with the disclosed embodiments. The system illustrated in FIG. 1 allows users to interact with the online social network from mobile devices, including a smartphone 104 and a tablet computer 108. The system also enables users to interact with the online social network through desktop systems 114 and 118 that access a website associated with the online application.

More specifically, mobile devices 104 and 108, which are operated by users 102 and 106 respectively, can execute mobile applications that function as portals to an online application, which is hosted on mobile server 110. Note that a mobile device can generally include any type of portable electronic device that can host a mobile application, including a smartphone, a tablet computer, a network-connected music player, a gaming console and possibly a laptop computer system.

Mobile devices 104 and 108 communicate with mobile server 110 through one or more networks (not shown), such as a WiFi® network, a Bluetooth™ network or a cellular data network. Mobile server 110 in turn interacts through proxy 122 and communications bus 124 with a storage system 128, which for example can be associated with an Apache Hadoop™ system. Note that although the illustrated embodiment shows only two mobile devices, in general a large number of mobile devices and associated mobile application instances (possibly thousands or millions) can simultaneously access the online application.

The above-described interactions allow users to generate and update “member profiles,” which are stored in storage system 128. These member profiles include various types of information about each member. For example, if the online social network is an online professional network, such as LinkedIn™, a member profile can include: first and last name fields containing a first name and a last name for a member; a headline field specifying a job title and a company associated with the member; and one or more position fields specifying prior positions held by the member.

The disclosed embodiments also allow users to interact with the online social network through desktop systems. For example, desktop systems 114 and 118, which are operated by users 112 and 116, respectively, can interact with a desktop server 120, and desktop server 120 can interact with storage system 128 through communications bus 124.

Note that communications bus 124, proxy 122 and storage device 128 can be located on one or more servers distributed across a network. Also, mobile server 110, desktop server 120, proxy 122, communications bus 124 and storage device 128 can be hosted in a virtualized cloud-computing system.

The computing environment 100 illustrated in FIG. 1 also includes an offline system 129, which periodically performs computations to optimize the performance of the online social network. For example, in an online professional network, offline system 129 can perform computations for a given member to identify other members that the given member will likely want to link to. This enables the system to suggest that the given member link to the identified members. Offline system 129 can also perform computations to determine which members are most likely to respond to specific advertising messages to facilitate effective targeted advertising to members of the online social network.

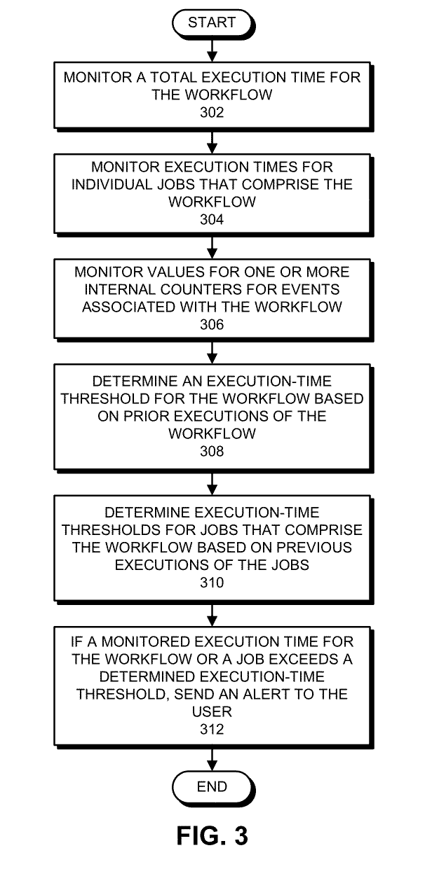

As illustrated in FIG. 1, offline system 129 executes a number of workflows (also referred to as “flows”) 141-143 under control of a flow scheduler 130, wherein flow scheduler 130 can possibly be implemented using the AZKABAN™ batch job scheduler which is an internal tool available as part of the LinkedIn™ online professional network. Flow scheduler 130 schedules the jobs within flows 141-143 to be executed on a computing cluster, which for example can reside on a system, such as Apache Hadoop™. While flows 141-143 are executing on the computing cluster, a monitoring mechanism 132 periodically retrieves data from flow scheduler 130. Monitoring mechanism 132 can also send alerts to a user 134 if a flow is taking too long to execute, and additionally enables user 134 to view various statistics from the flows to facilitate determining the cause of a performance problem. Monitoring mechanism 132 is described in more detail below with reference to FIGS. 3-9.

### Executing Flow Graphs on a Computing Cluster

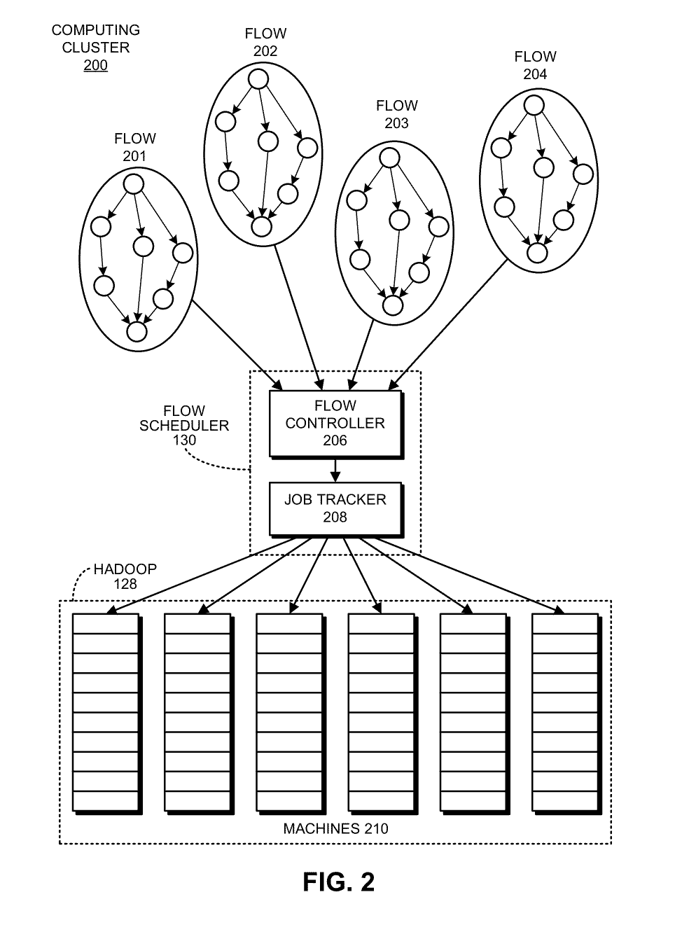

FIG. 2 illustrates how workflows represented as “flow graphs,” representing a set of jobs and associated dependencies, can be executed on a computing cluster 200 in accordance with the disclosed embodiments. Computing cluster 200 comprises a number of machines 210 (computing nodes) that are capable of executing independently, as well as a flow controller 206 and a job tracker 208 (which are contained within flow scheduler 130). Each of the flows 201-204 is represented as a flow graph comprised of “nodes” and “arcs,” wherein each node represents a separately executable job, and each arc represents a dependency between two jobs. Note that a dependency between a first job and a second job indicates that the first job must complete before the second job can begin executing.

During operation of the system illustrated in FIG. 2, flow controller 206 walks each flow graph for a flow (from source to sink) and sends executable jobs to job tracker 208. Job tracker 208 in turn sends each job to a specific machine within the set of machines 210 and monitors the execution of the jobs. (In one embodiment, the set of machines 210 is part of the Apache Hadoop™ system.) When a job completes, the associated flow graph is updated to indicate the completion, which can potentially clear a dependency, thereby enabling another job to execute.

Note that a related set of workflows can collectively form a “macro-flow,” which includes a set of interrelated workflows with associated interdependencies. In addition to optimizing the execution of a single workflow, the system can also optimize the execution of a macro-flow associated with multiple interrelated workflows.

### Monitoring Process

FIG. 3 presents a flow chart illustrating how a workflow is monitored in accordance with the disclosed embodiments. During operation, the system monitors a total execution time for the workflow, wherein the workflow comprises a set of jobs that execute on nodes of a computing cluster (step 302). The system also monitors execution times for individual jobs in the set of jobs that comprise the workflow (step 304). The system additionally monitors values for one or more internal counters for events associated with the workflow (step 306). For example, in the case of an online professional network such as LinkedIn™, the counter can keep track of various user actions, such as: (1) how many emails were sent by a set of users; (2) how many endorsements were made by a set of users; or (3) how many “click-throughs” to other websites were performed by a set of users.

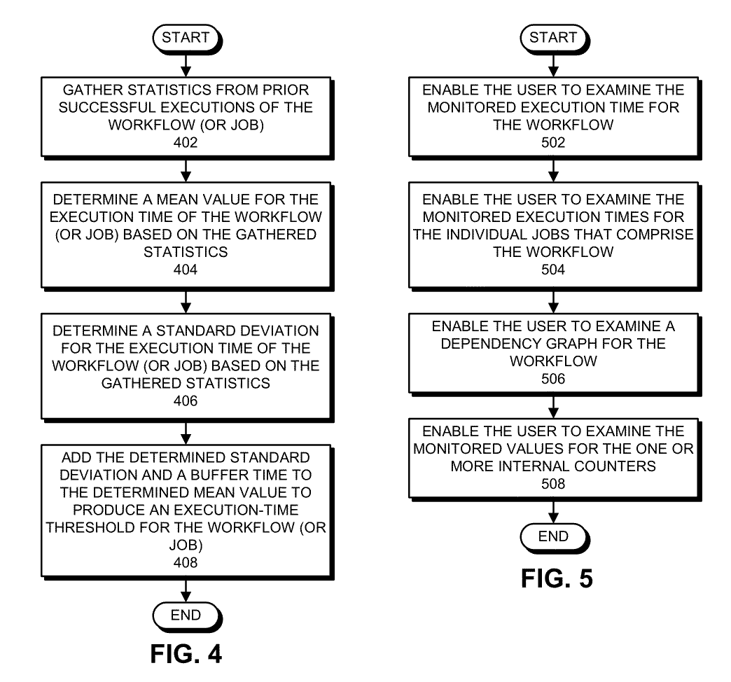

Next, the system periodically determines an execution-time threshold for the workflow based on prior executions of the workflow (step 308). The system similarly determines execution-time thresholds for jobs that comprise the workflow based on previous executions of the jobs (step 310). FIG. 4 illustrates how an execution-time threshold for a workflow or a job can be computed. The system first gathers statistics from prior successful executions of the workflow or the job (step 402). Next, the system determines a mean value for the execution time of the workflow or job based on the gathered statistics (step 404). The system also determines a standard deviation for the execution time of the job or the workflow (step 406). For example, the standard deviation can be a first standard deviation, a second standard deviation, a third standard deviation, or a fractional standard deviation. Finally, the system adds the determined standard deviation and a buffer time (e.g., 30 seconds) to the computed mean value to produce an execution-time threshold for the workflow or job (step 408).

Returning to FIG. 3, after the execution-time thresholds have been computed, if the monitored execution time for a workflow or a job exceeds a determined execution-time threshold for the workflow or job, the system sends an alert to the user 134 (step 312).

After user 134 receives an alert for a workflow or a job, user 134 may want to examine status information relating to the execution of the workflow. Referring to the flow chart illustrated in FIG. 5, while providing such status information, the system can enable the user to examine the monitored execution time for the workflow (step 502). The system can also enable the user to examine the monitored execution times for the individual jobs that comprise the workflow (step 504). The system can additionally enable the user to examine a dependency graph for the workflow (step 506). Finally, the system can enable the user to examine the monitored values for the one or more internal counters (step 508).

### Monitoring Tool Views

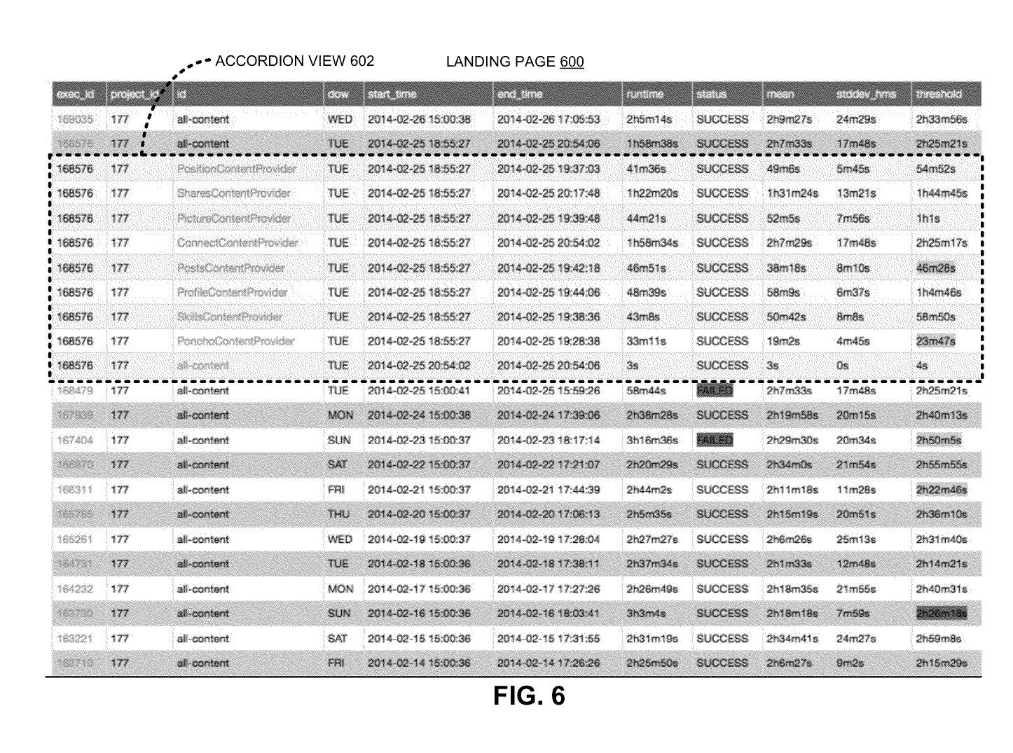

FIG. 6 illustrates an exemplary landing page 600 for a monitoring tool in accordance with the disclosed embodiments. As illustrated in FIG. 6, landing page 600 displays execution statistics for a number of workflows that have executed. For each of these workflows, landing page 600 provides statistics, including: (1) an identifier for the specific execution of the workflow (exec_id); (2) an identifier for a project associated with the workflow (project_id); (3) a textual identifier for the workflow (id); (4) a day-of-the-week that the workflow executed (dow); (5) a start time for the workflow (start_time); (6) an end time for the workflow (end_time); (7) a run time for the workflow (runtime); (8) an execution status for the workflow (status), which can indicate “SUCCESS,” “FAILED,” or “KILLED”; (9) a mean value for the execution time for the workflow (mean); (10) a standard deviation for the execution time for the workflow (stddev_hms); and (11) an execution-time threshold for the workflow (threshold).

Landing page 600 can also provide an accordion view 602, wherein a specific workflow exec_id=168576 is expanded to display the jobs that comprise the workflow, along with statistics for the jobs. This accordion view 602 is produced when the user clicks on the parent workflow. Similarly, if the user clicks on an individual job, the system can display job history information.

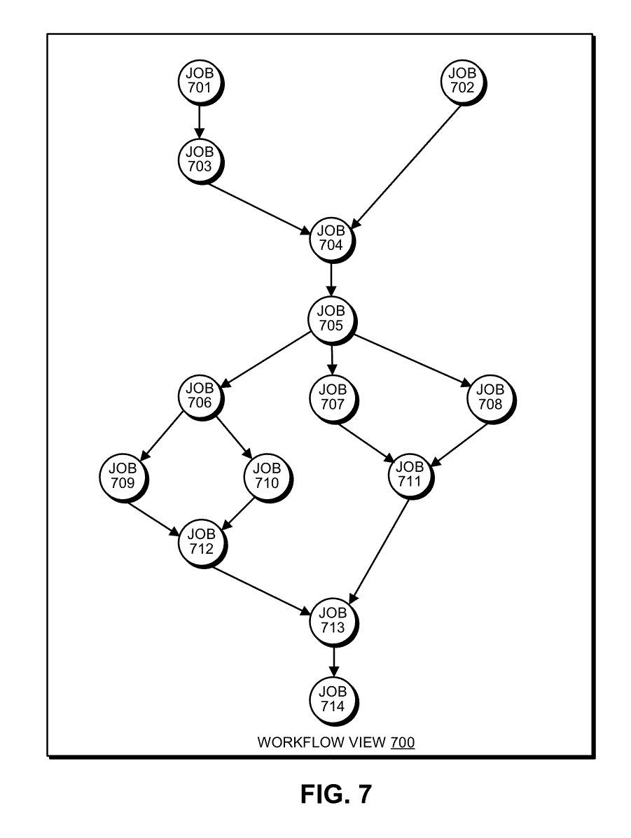

The user can also examine a workflow view 700 for a specific workflow as illustrated in FIG. 7. This workflow view 700 illustrates the dependencies among the individual jobs 701-714 that comprise the workflow, which helps the user to determine where performance bottlenecks are likely to exist.

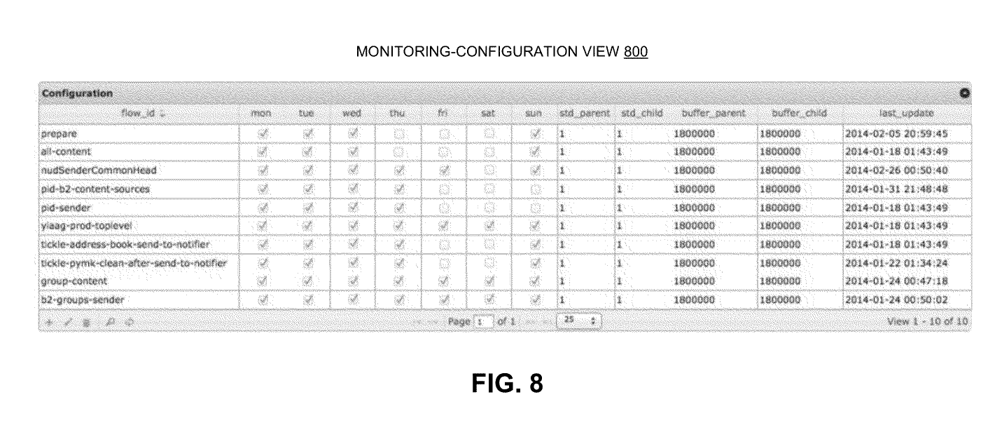

FIG. 8 illustrates a monitoring-configuration view 800 for the monitoring tool in accordance with the disclosed embodiments. This view illustrates various parameters for the monitoring tool that the user can set. The first column in FIG. 8 contains a textual workflow identifier (flow_id). The next seven columns contain checkboxes for days of the week, which enable the user to configure the workflow to execute on specific days of the week. The next column contains a standard deviation for the workflow (std_parent) that is set to a value of “1” standard deviation, but can possibly be set to “2” or “3” standard deviations or a fractional standard deviation. The next column contains a corresponding standard deviation for the jobs that comprise the workflow (std_child). The next column specifies a buffer time in milliseconds for the workflow (buffer_parent), wherein as explained above the buffer time is added to the standard deviation and the mean to compute the execution-time threshold. The next column specifies a buffer time for the jobs that comprise the workflow (buffer_child). Finally, the last column specifies a last update time for the configuration information for the workflow (last_update).

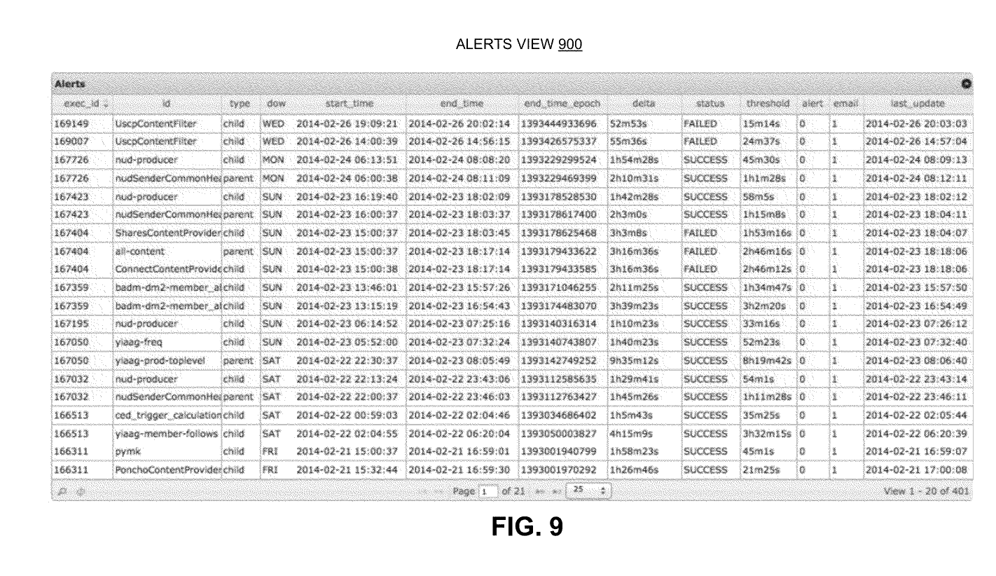

FIG. 9 illustrates an alerts view 900 for the monitoring tool in accordance with the disclosed embodiments. Alerts view 900 presents a list of all of the alerts that have been generated by the monitoring tool. Each entry in alerts view 900 includes the same information as presented in the landing page 600 and additionally includes an alert indicator (alert), and an email indicator (email). This alert indicator is set to a value of “1” when an execution-time threshold is initially breached. After a fixed period of time elapses (say 30 minutes), an email is sent to the user, the email indicator is set to one and the alert indicator is cleared. Finally, the last column specifies a last update time for the associated alert record (last_update).

The foregoing descriptions of disclosed embodiments have been presented only for purposes of illustration and description. They are not intended to be exhaustive or to limit the disclosed embodiments to the forms disclosed. Accordingly, many modifications and variations will be apparent to practitioners skilled in the art. Additionally, the above disclosure is not intended to limit the disclosed embodiments. The scope of the disclosed embodiments is defined by the appended claims.

What is claimed is:

1. A computer-implemented method for monitoring a workflow, the method comprising:
monitoring an execution time for the workflow, wherein the workflow comprises a set of jobs that execute on nodes of a computing cluster;
while monitoring the execution time for the workflow, monitoring execution times for individual jobs in the set of jobs that comprise the workflow;
determining an execution-time threshold for the workflow based on prior executions of the workflow;
if a monitored execution time for the workflow exceeds the determined execution-time threshold for the workflow, sending an alert about the workflow to a user; and
enabling the user to examine the monitored execution time for the workflow and the monitored execution times for the individual jobs that comprise the workflow.

2. The computer-implemented method of claim 1, wherein the method further comprises:
determining execution-time thresholds for jobs that comprise the workflow based on previous executions of the jobs; and
if an execution time for a job exceeds the determined execution-time threshold for the job, sending an alert about the job to the user.

3. The computer-implemented method of claim 1, wherein the method further comprises enabling the user to examine a dependency graph for the workflow to facilitate determining a solution to a performance problem for the workflow, wherein the dependency graph specifies dependencies between jobs in the workflow, and wherein a dependency between a first job and a second job indicates that the first job must complete before the second job can begin executing.

4. The computer-implemented method of claim 1, wherein determining the execution-time threshold for the workflow includes:
determining a mean value and a standard deviation for the execution time for the workflow based on prior successful executions of the workflow; and
adding the determined standard deviation and a buffer time to the determined mean value to produce the execution-time threshold.

5. The computer-implemented method of claim 4, wherein enabling the user to examine the monitored execution time for the workflow involves enabling the user to examine parameters for the workflow, including:
an identifier for the workflow;
a day-of-the-week that the workflow was executed on;
a start time for the workflow;
an end time for the workflow;
a run time for the workflow;
an execution status for the workflow;
a mean value for the execution time for the workflow;
a standard deviation for the execution time for the workflow; and
the execution-time threshold for the workflow.

6. The computer-implemented method of claim 4, further comprising enabling the user to configure:
the buffer time; and
a magnitude for the standard deviation.

7. The computer-implemented method of claim 1,
wherein monitoring the execution time for the workflow involves monitoring values for one or more internal counters for events associated with the workflow; and
wherein enabling the user to examine the monitored execution time for the workflow also includes enabling the user to examine the monitored values for the one or more internal counters.

8. A non-transitory computer-readable storage medium storing instructions that when executed by a computer cause the computer to perform a method for monitoring a workflow, the method comprising:
monitoring an execution time for the workflow, wherein the workflow comprises a set of jobs that execute on nodes of a computing cluster;
while monitoring the execution time for the workflow, monitoring execution times for individual jobs in the set of jobs that comprise the workflow;
determining an execution-time threshold for the workflow based on prior executions of the workflow;
if a monitored execution time for the workflow exceeds the determined execution-time threshold for the workflow, sending an alert about the workflow to a user; and
enabling the user to examine the monitored execution time for the workflow and the monitored execution times for the individual jobs that comprise the workflow.

9. The non-transitory computer-readable storage medium of claim 8, wherein the method further comprises:
determining execution-time thresholds for jobs that comprise the workflow based on previous executions of the jobs; and
if an execution time for a job exceeds the determined execution-time threshold for the job, sending an alert about the job to the user.

10. The non-transitory computer-readable storage medium of claim 8, wherein the method further comprises enabling the user to examine a dependency graph for the workflow to facilitate determining a solution to a performance problem for the workflow, wherein the dependency graph specifies dependencies between jobs in the workflow, and wherein a dependency between a first job and a second job indicates that the first job must complete before the second job can begin executing.

11. The non-transitory computer-readable storage medium of claim 8, wherein determining the execution-time threshold for the workflow includes:
determining a mean value and a standard deviation for the execution time for the workflow based on prior successful executions of the workflow; and
adding the determined standard deviation and a buffer time to the determined mean value to produce the execution-time threshold.

12. The non-transitory computer-readable storage medium of claim 11, wherein enabling the user to examine the monitored execution time for the workflow involves enabling the user to examine parameters for the workflow, including:
an identifier for the workflow;
a day-of-the-week that the workflow was executed on;
a start time for the workflow;
an end time for the workflow;
a run time for the workflow;
an execution status for the workflow;
a mean value for the execution time for the workflow;
a standard deviation for the execution time for the workflow; and
the execution-time threshold for the workflow.

13. The non-transitory computer-readable storage medium of claim 11, further comprising enabling the user to configure:
the buffer time; and
a magnitude for the standard deviation.

14. The non-transitory computer-readable storage medium of claim 8,
wherein monitoring the execution time for the workflow involves monitoring values for one or more internal counters for events associated with the workflow; and
wherein enabling the user to examine the monitored execution time for the workflow also includes enabling the user to examine the monitored values for the one or more internal counters.

15. A system that monitors execution of a workflow, comprising:
a computing cluster comprising a plurality of processors and associated memories;
a monitoring mechanism that executes on the computing cluster and is configured to,
monitor an execution time for the workflow, wherein the workflow comprises a set of jobs that execute on nodes of a computing cluster;
monitor execution times for individual jobs in the set of jobs that comprise the workflow;
determine an execution-time threshold for the workflow based on prior executions of the workflow;
if a monitored execution time for the workflow exceeds the determined execution-time threshold for the workflow, send an alert about the workflow to a user; and
enable the user to examine the monitored execution time for the workflow and the monitored execution times for the individual jobs that comprise the workflow.

16. The system of claim 15, wherein the monitoring mechanism is further configured to:
determine execution-time thresholds for jobs that comprise the workflow based on previous executions of the jobs; and
if an execution time for a job exceeds the determined execution-time threshold for the job, send an alert about the job to the user.

17. The system of claim 15, wherein the monitoring mechanism is further configured to enable the user to examine a dependency graph for the workflow to facilitate determining a solution to a performance problem for the workflow, wherein the dependency graph specifies dependencies between jobs in the workflow, and wherein a dependency between a first job and a second job indicates that the first job must complete before the second job can begin executing.

18. The system of claim 15, wherein while determining the execution-time threshold for the workflow, the monitoring mechanism is configured to:
determine a mean value and a standard deviation for the execution time for the workflow based on prior successful executions of the workflow; and
add the determined standard deviation and a buffer time to the determined mean value to produce the execution-time threshold.

19. The system of claim 18, wherein enabling the user to examine the monitored execution time for the workflow involves enabling the user to examine parameters for the workflow, including:
an identifier for the workflow;
a day-of-the-week that the workflow was executed on;
a start time for the workflow;
an end time for the workflow;
a run time for the workflow;
an execution status for the workflow;
a mean value for the execution time for the workflow;
a standard deviation for the execution time for the workflow; and
the execution-time threshold for the workflow.

20. The system of claim 18, wherein the monitoring mechanism is further configured to enable the user to set:
the buffer time; and
a magnitude for the standard deviation.

21. The system of claim 15,
wherein while monitoring the execution time for the workflow, the monitoring mechanism is configured to monitor values for one or more internal counters for events associated with the workflow; and
wherein while enabling the user to examine the monitored execution time for the workflow, the monitoring mechanism is configured to enable the user to examine the monitored values for the one or more internal counters.
